(19) United States
(12) Patent Application Publication
(10) Pub. No.: US 2024/0001458 A1
(43) Pub. Date: Jan. 4, 2024

(54) ROTARY TOOL AS WELL AS CUTTING INSERT AND CARRIER FOR SUCH A ROTARY TOOL

(71) Applicant: KENNAMETAL INC., Latrobe, PA (US)

(72) Inventors: Michael Schuffenhauer, Fuerth (DE); Bemhard Eckl, Fuerth (DE); Berthold Zeug, Fuerth (DE)

(21) Appl. No.: 18/213,570

(22) Filed: Jun. 23, 2023

(30) Foreign Application Priority Data
Jun. 30, 2022 (DE) 102022206733.9

(51) Int. Cl. B23B 51/00

(52) U.S. Cl. CPC B23B 51/0007; B23B 2251/04

(57) ABSTRACT

The invention relates to a rotary tool (2) extending longitudinally from a shank region (8) to a front-facing end region along an axis of rotation (6) and having a carrier (4) with a plate seat (14) and a cutting insert (16) that can be replaceably inserted therein. The cutting insert (16) as well as the plate seat (14) each have radial and axial contact surfaces (40A, B) which are strained against one another with the aid of a clamping screw (50) during assembly of the cutting insert (16). According to the invention, it is provided that the axial contact surfaces (40A, B) and in particular also the radial contact surfaces (42A, B) are inclined in a V shape on one side of the cutting insert (16) and on the other side of the plate seat (14), so that a centering effect is automatically produced during assembly.

### RELATED APPLICATION DATA

The present application claims priority under 35 U.S.C. § 119 to German Patent Application No. 102022206733.9, filed on Jun. 30, 2022, the disclosure of which is incorporated by reference herein in its entirety.

### FIELD

The invention relates to a modular rotary tool, specifically to a drilling tool, which comprises a carrier and a cutting insert mounted in a reversibly replaceable manner on the front face of the carrier.

### BACKGROUND

A variety of concepts exist for reversible mounting of the cutting insert. Often, the carrier has free-standing retaining webs or clamping webs on the front-facing end, between which a receptacle for the cutting insert is formed, thereby forming a plate seat. The cutting insert is often held in the plate seat using a screw.

In order to ensure a good centering of the cutting insert in the plate seat, the retaining webs typically exert a clamping force on the cutting insert. This makes assembly more difficult, as the retaining webs in this case exert a bias that must be overcome when inserting and also when replacing the cutting insert.

### SUMMARY

Based on the above, the problem addressed by the invention is to specify a rotary tool as well as a cutting insert and a carrier for such a rotary tool, wherein a good centering of the cutting insert in the plate seat is ensured without the need for a bias. The problem according to the invention is solved by a rotary tool extending longitudinally from a shank region to a front-facing end region along an axis of rotation and having a carrier with a cutting insert that can be replaceably inserted therein, wherein:
the carrier at a front-facing end forms a plate seat comprising two opposing retaining webs, which are in particular free-standing in the longitudinal direction, between which a receptacle is formed with a floor into which the cutting insert is replaceably inserted,
a clamping screw is provided, with the aid of which the cutting insert in the receptacle is retracted during assembly of the cutting insert,
the cutting insert comprises a front face with a front cutting tip and two radially outer cutting corners as well as two opposing radial wings,
a center plane is defined, which is subtended in the longitudinal direction through the axis of rotation and in a first transverse direction that extends perpendicular to the longitudinal direction, wherein the center plane passes centrally between the cutting tips and the retaining webs, and wherein a second transverse direction is further defined, which extends perpendicular to the longitudinal direction and perpendicular to the first transverse direction,
a respective lateral, radial contact surface is formed on a respective retaining web and on a respective wing,
respective axial contact surfaces are formed on the floor of the receptacle and thus of the plate seat and on the floor side of the wings, wherein
in the assembled state, the respective contact surfaces of the plate seat abut against those of the wings,
at least the axial contact surfaces of the receptacle as well as the axial contact surfaces of the wings, when viewed in a projection in the direction of the second transverse direction, are respectively oriented in a V shape in relation to one another, such that the cutting insert is held centered in the receptacle.

According to the present invention, the problem is further solved by a cutting insert having the aforementioned features as well as by a carrier having the aforementioned features. The following preferred further developments given with respect to the rotary tool are also to be transferred to the carrier or the cutting insert accordingly.

Both the axial contact surfaces of the wings on the one hand and the axial contact surfaces of the plate seat on the other hand are therefore oriented in relation to one another at an angle that is generally smaller than 180° and thus in a V shape. The tip of this conceptual V preferably points in the direction of a rear end of the carrier or cutting insert, which is arranged opposite the front-facing end region.

Via the clamping screw, an axial tensile force is generated counter to the longitudinal direction and into the plate seat during the assembly of the cutting insert. As a result, the axial contact surface pairs are pressed against one another. Due to the V-shaped arrangement, centering forces act when the clamping screw is tightened, so that the cutting insert is centered with respect to the plate seat.

Due to this automatic centering effect, a bias, which is already applied during insertion by the retaining webs, can therefore be omitted, which simplifies the assembly as well as the disassembly, i.e., a change of the cutting insert is generally simplified.

The cutting insert is preferably formed in a plate-like fashion and extends only between the two retaining webs in the direction of the 1st transverse direction through the retaining webs. Preferably, it does not have any front radial protrusions that cover the retaining webs in the radial direction.

The cutting insert typically has a center region or core, on which the cutting tip is formed on the front face and to which the two wings respectively connect radially outward in an opposing manner. From the cutting tip, a cutting portion of a main blade typically extends along each wing, which extends to the radially outer cutting corner.

In the present case, when radial contact surfaces are referred to, this means lateral contact surfaces that bound the retaining webs inwardly in the direction of the receptacle and, on the sides of the wings, also laterally outward in the direction of the retaining webs.

Typically, the carrier has a grooved cutting region, wherein typically two flutes are provided, preferably spiraling along the length of the carrier. These typically open on the front face into a free intermediate region between the retaining webs.

Preferably, the cutting insert is also equipped with fluted portions so that the flutes of the carrier continue to be passed through them with the cutting insert inserted.

Preferably, the radial contact faces each come to a tapered stop at the clamping webs and at the wings in the direction of the front face, i.e., the radial contact faces are not covered by a radial overhang on the carrier or on the cutting insert.

Preferably, the radial contact surfaces come to a tapered stop in the radial direction, therefore, in particular they extend up to an outer circumferential side of the cutting insert or the carrier.

Preferably, the axial contact surfaces of the cutting insert and/or the plate seat come to a tapered stop. The axial contact surfaces of the cutting insert are therefore not covered in the radial direction by an overhang of the cutting insert. The axial contact surfaces of the plate seat are also not covered in the radial direction by an overhang of the plate seat.

In a preferred configuration, in addition to the axial contact surfaces, the radial contact surfaces are also oriented in a V shape in relation to one another when viewed in a projection in the direction of the first transverse direction. The radial, lateral contact surfaces of the wings on the one hand and the plate seat on the other hand are therefore oriented in relation to one another at an angle of less than 180°. Here too, the conceptual V peak is preferably directed counter to the longitudinal direction and thus in the direction of the rear end of the carrier or cutting insert.

This configuration with the axial and radial contact surfaces oriented in a V shape in relation to one another thus creates a V-shaped arrangement in two directions and thus doubled, whereby a centering in two different directions takes place, in particular in the direction of the two transverse directions, so that the cutting insert is reliably aligned concentrically with the axis of rotation overall.

As an alternative to the V-shaped arrangement of the radial contact surfaces, they can also be oriented parallel to one another, in which case additional measures are preferably taken for a centering in the second direction.

In preferred further development, the axial contact surfaces pass, in a projection in the direction of the 1st transverse direction, each inclined at an angle of inclination with respect to the 2nd transverse direction, and in particular diminishing in the direction of the nearest radial contact surface. The desired centering effect is thereby additionally favored.

In a preferred configuration, the cutting insert as well as the plate seat have a radially inward center region, wherein radial guide surfaces are formed on the respective center region, which, when viewed counter to the longitudinal direction, are oriented at an angle to the radial contact surfaces. Thus, in a direction of view counter to the longitudinal direction, such a radial guide surface connects to the radial contact surfaces towards the inner center region. These assist with the insertion of the cutting insert. In the fully assembled state, for example, the guide surfaces of the cutting insert no longer abut against those of the plate seat.

Preferably, the receptacle and thus the plate seat are sized such that the cutting insert is insertable into the receptacle without biasing, i.e., without the need to elastically widen the retaining webs when inserting the cutting insert. The secure, centered seat of the cutting insert is only achieved upon tightening of the clamping screw.

The axial contact surfaces preferably enclose an obtuse angle between themselves, in particular in the range of 110° to 160°.

The radial contact surfaces preferably enclose an acute angle between themselves, in particular in the range between 5° and 35°.

The aforementioned angle of inclination remains preferably in the range between 5° and 200.

With these angular ranges, a good centering effect is achieved.

The radial contact surfaces are preferably planar, flat surfaces. The radial contact surfaces expediently extend parallel to the central plane.

As already mentioned, the radial contact surfaces preferably come to a tapered stop in the direction of the front face. They therefore preferably extend, at least in a radially outer region, over the entire expanse of the retaining webs or the wings in the longitudinal direction.

According to a first design variant, the axial contact surfaces are flat, planar surfaces.

According to a preferred design and alternative in this respect, the axial contact surfaces are cylindrical lateral surfaces, in particular conical lateral surfaces. Cylinder lateral surface or conical lateral surface is understood in the present context to mean a circumferential portion of a cylindrical surface or a conical surface. The conceptual cylindrical axis or conical axis is preferably oriented in the direction of the axis of rotation. In the case of a conical surface, the conceptual cone tip is preferably oriented in the direction of the axis of rotation. Such a configuration of the axial contact surfaces is particularly easy to design in terms of manufacturing technology. Furthermore, it is advantageous in this case that, due to the now bent surface, an additional centering effect in a second direction is already achieved in addition to the inclination as a result of the V-shaped arrangement. Specifically, with such a design, it is therefore possible that the V-shaped arrangement of the radial contact surfaces can be omitted and that they extend, for example, parallel to the longitudinal direction.

As already stated, the cutting insert is stressed in the plate seat using the clamping pin. The cutting insert preferably has an axial clamping pin on the floor-side, thus projecting in the longitudinal direction, which has a notch on its circumference, for example, which is configured as a circumferential annular groove or alternatively extends only over a defined circumferential portion. In the latter case, a plurality of discrete notches can also be distributed around the circumference and machined at the same axial height.

With the cutting insert mounted, the clamping pin is inserted into a pin receptacle on the carrier, which is formed on the floor side of the receptacle. The clamping screw is now inserted radially through the carrier from the outside. The clamping screw exerts a force on the cutting insert counter to the longitudinal direction. Preferably, a threaded hole is configured on the carrier that extends obliquely with respect to the axis of rotation, through which the clamping screw is passed. The threaded hole encloses an acute angle in the longitudinal direction.

### BRIEF DESCRIPTION OF THE DRAWINGS

Exemplary embodiments of the invention are explained in further detail in the following with reference to the figures. These show:

FIG. 1 a perspective view of a modular rotary tool configured as a drilling tool,

FIG. 2 a sectional lateral view onto the rotary tool in the region of the cutting insert with the direction of view along a 1st transverse direction,

FIG. 3 a sectional lateral view analogous to FIG. 2, however after a 90° rotation about the axis of rotation and with the direction of view along a 2nd transverse direction,

FIG. 4 a front view of the rotary tool,

FIG. 5 a front view of the cutting insert,

FIG. 6 a side view of the cutting insert with the direction of view along the 1st transverse direction,

FIG. 7 a side view of the cutting insert analogous to FIG. 6 after a 90° rotation with the direction of view along the 2nd transverse direction,

FIG. 8 a sectional perspective view of the carrier, without the cutting insert,

FIG. 9A a sectional side view with a cutting line A-A,

FIG. 9B a sectional view according to the cutting line A-A according to FIG. 9A,

FIG. 10 a sectional side view of a second design variant with the direction of view along the 1st transverse direction.

### DETAILED DESCRIPTION

A modular rotary tool 2 shown in FIG. 1 is configured as a drilling tool and comprises a carrier 4 that extends along a longitudinal direction z and an axis of rotation 6 from a rear shank region 8 to a front-facing end region of the rotary tool 2. A grooved cutting region 12 adjoins the shank region 8, which forms a plate seat 14 at its front-facing end, in which a cutting insert 16 is received.

In the exemplary embodiment, the cutting region 12 comprises wound flutes 18 which are continued in the cutting insert 16.

The cutting insert 16 is inserted between two retaining webs 20 of the plate seat 14, which define between themselves a receptacle 22 that is bounded laterally by the two retaining webs 20 and on the floor-side by a floor 24. In the floor 24, a pin receptacle 25 is configured in the manner of a bore, which extends into the carrier 4 counter to the longitudinal direction (cf. in particular also FIG. 8 in this regard).

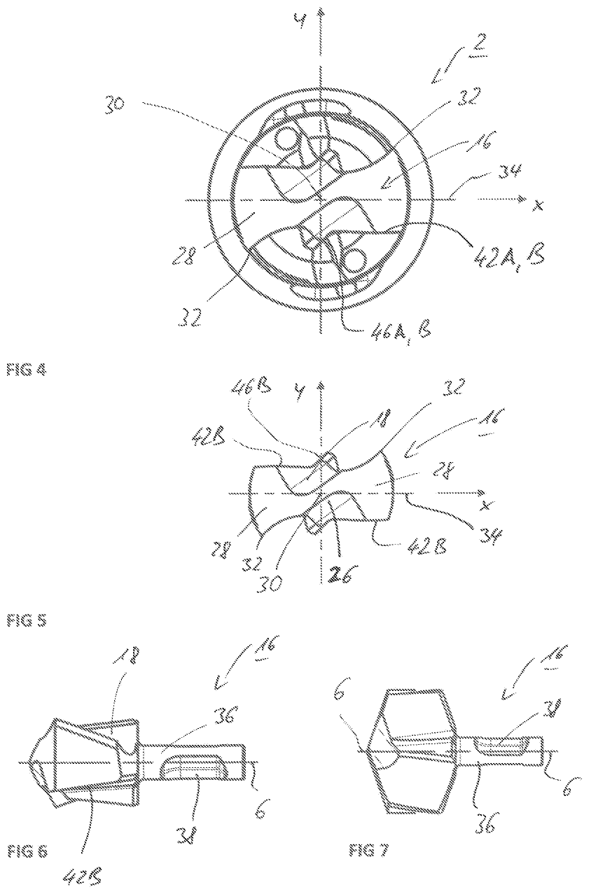

As can be seen in particular from FIGS. 4-7, the cutting insert 16 is configured overall in the manner of a plate-shaped element, which has a radially inner center region 26 quasi as a core, to which a radially outwardly extending wing 28 is respectively connected in an opposing manner. The aforementioned flutes 18 extend laterally into the center region and also into a part of the wings 28 and come to a tapered stop on the front face. Starting from a cutting tip 30, cutting portions extend radially outward to cutting corners 32 in the manner known per se.

The two wings 28 each extend along a 1st transverse direction x, i.e., a respective wing 28 adjoins the center region 26 in or counter to this 1st transverse direction x. Vertically, a 2nd transverse direction y is defined. The two transverse directions x, y are also each oriented perpendicularly to the longitudinal direction z.

As can be seen in FIG. 5 in particular, the 1st transverse direction x as well as the longitudinal direction z define a central plane 34, which therefore extends centrally between the two cutting corners 32 and through the cutting tip 30 or centrally between the retaining webs 20 and through the axis of rotation 6.

Counter to the longitudinal direction z, a pin-like or rod-like heel referred to as a clamping pin 36 adjoins on the floor side. This is, for example, a monolithic subpiece of the cutting insert 16 or alternatively attached thereto, for example screwed. The clamping pin 36 has at least one notch 38.

The plate seat 14 is configured overall such that the cutting insert 16 can be inserted into the plate seat 14 without biasing. This means in particular that the retaining webs 20 do not have to be elastically bent open for insertion of the cutting insert 16. The cutting insert 16 therefore is thus not excessively large with respect to the receptacle 22. Rather, a certain amount of play is given between the cutting insert 16 and the plate seat 14.

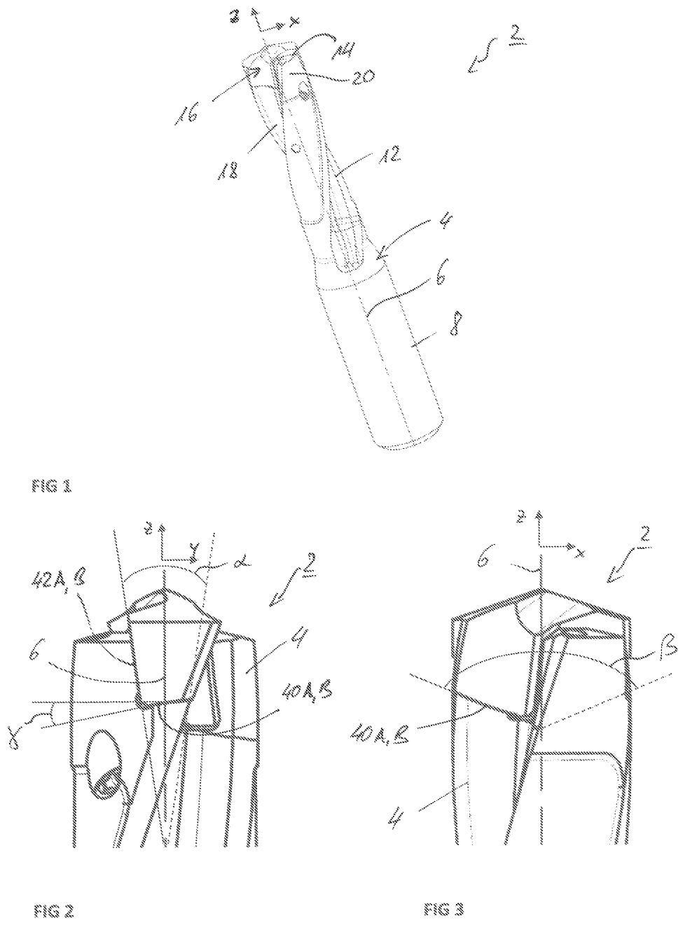

In order to ensure a reliable centering of the cutting insert 16 within the plate seat 14 and thus concentrically to the axis of rotation 6, two axial contact surfaces 40A, B and two radial contact surfaces 42A, B are formed on the plate seat 14 as well as on the cutting insert 16, whose function is explained in more detail in connection with FIGS. 2 and 3.

The contact surfaces 40A, 42A denoted by letter A relate to the contact surfaces of the plate seat 14, and the contact surfaces 40B, 42B denoted by letter B relate to the cutting insert 16.

In the plate seat 14, the radial contact surfaces 42A are respectively formed laterally on the retaining webs 20, namely on their side facing the receptacle 22. These contact surfaces 42A are preferably flat, planar surfaces that extend over the entire length of the retaining webs 20 in the longitudinal direction z and come to a tapered stop radially outward at a circumferential side.

The axial contact surfaces 40A are formed on the floor 24 and extend radially outward proceeding from the pin receptacle 25. They come to a tapered stop in the flutes 18.

In the cutting insert 16, each wing 28 has a radial contact surface 42B, which is also configured as a side surface oriented in the direction of the respective retaining web 20. The radial contact surface 42B is preferably also respectively configured as a flat, planar surface. Preferably, it extends over a total wing height in the longitudinal direction z and also comes to a tapered stop radially outwards at a circumferential side of the cutting insert 16.

The axial contact surfaces 40B are formed on the floor side and thus on the lower end of a respective wing 28. The respective axial contact surface 40B preferably extends over the entire width (in the direction of the 2nd transverse direction) of the respective wing 28. It preferably also extends, adjoining the center region 26, along the entire length of the wing 28 (in the direction of the 1st transverse direction) up to a radially outer circumferential region and comes to a tapered stop there.

FIG. 2 shows a side view onto the cutting insert 16 arranged in the plate seat 14 with a direction of view in the direction of the 1st transverse direction x. From this perspective, the radial contact surfaces 42A, B can be readily discerned on the side facing the direction of view. The corresponding radial contact surfaces 42A, B on the opposite side are indicated by the dashed line. It can easily be discerned that the radial contact surfaces 42A, B of the cutting insert 16 on the one hand and the plate seat 14 on the other hand are arranged in a V-shape, wherein the tip of the V-shaped arrangement points downward, i.e., in the direction of the rear end of the rotary tool 2. The radial contact surfaces 42A, B enclose an acute angle α between themselves, which ranges from 5° to 30°, and preferably from 15° to 25°. In the exemplary embodiment, it is nearly 20°. This simultaneously means that a respective radial contact surface 42 A, B encloses the half angle α relative to the longitudinal direction z.

Furthermore, the axial contact surfaces 40A, B can also be seen from FIG. 2, and in particular from FIG. 3.

FIG. 3 shows a direction of view along the 2nd transverse direction y. In this projection, the axial contact surfaces 40A, B can be seen on the side facing the direction of view, and the side facing away from the opposite side is in turn outlined by a dashed line. The axial contact surfaces 40A, B of the cutting insert 16 on the one hand and of the plate seat 14 on the other hand enclose an obtuse angle β between themselves. This ranges from 110° to 160°, for example, and in the exemplary embodiment is about 135°. A respective axial contact surface 40A, B, in turn, encloses a half angle β in the longitudinal direction z.

The direction of view according to FIG. 2 further indicates that the axial contact surfaces 40A, B are formed in a direction that is inclined downward in the direction of the respective nearest radial contact surface 42A, B at an angle of inclination y. The angle γ is preferably in the range between 5° and 20° and in the exemplary embodiment is a little over 10°.

Both the cutting insert 16 and the plate seat 14 are typically symmetrically formed with respect to the axis of rotation 6. When viewed along the 1st transverse direction x, two halves can therefore be identified, each of which has an axial contact surface 40A, B as well as a radial contact surface 42A, B. The closest radial contact surface is understood to mean the radial contact surface of the half on which the axial contact surface is also formed.

In the exemplary embodiment shown in FIGS. 2 and 3, the axial contact surfaces 40A, B are configured as flat, planar surfaces.

According to a second, preferred design variant, as shown in FIG. 10, these contact surfaces 40A, B are configured as cylindrical lateral surfaces and in particular as conical lateral surfaces. That is to say, in a side view in the direction of view of the 1st transverse direction x (i.e., analogous to FIG. 2), the respective axial contact surface 40A, B, extends along an arc line as shown by the dashed line in FIG. 10. In this respect, the axial contact surfaces 40A of the plate seat 14 are concave and the axial contact surfaces 40B of the cutting insert 16 are correspondingly convexly curved. Such curved surfaces are significantly easier to produce in manufacturing technology and, in addition, an improved surface contact between the contact surfaces 40A, B is thereby achieved.

Guide surfaces 46B can still be seen from the front view on the cutting insert 16 based on FIG. 5, wherein corresponding guide surfaces 46A are preferably also configured correspondingly on the plate seat 12.

These guide surfaces 46B are formed in the center region 26 and, when viewed in the projection counter to the longitudinal direction z, are angled at the inner end of the respective radial contact surface 42A. Specifically, an obtuse angle is formed, for example between 110° and 150° and in the exemplary embodiment 135°. These guide surfaces 46B assist in inserting the cutting insert 16 into the plate seat 14.

Based on FIGS. 6 and 7, the clamping pin 36 with the at least one notch 38 formed therein can be seen particularly well.

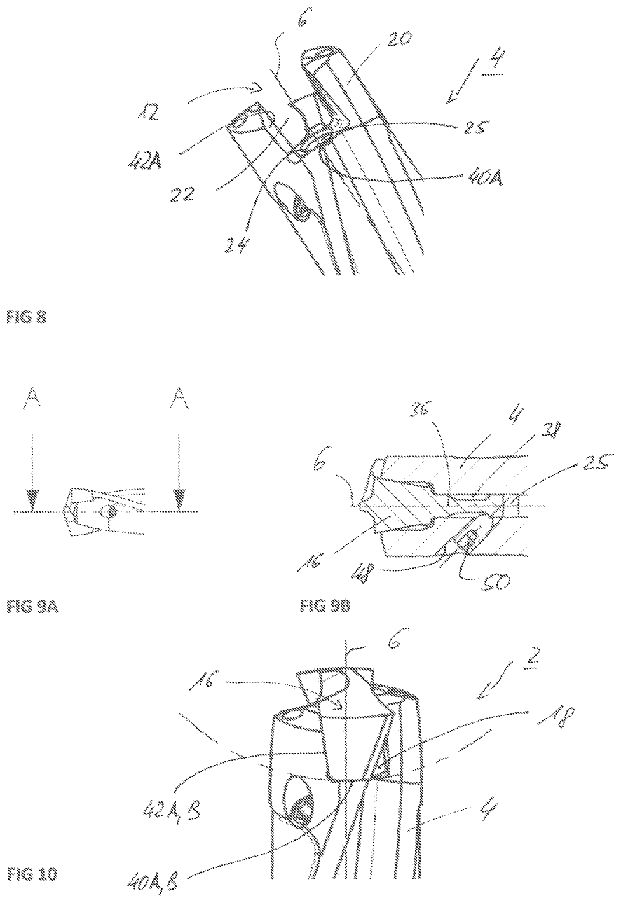

As can be seen in FIGS. 9A and 9B in particular, a threaded hole 48, which is oriented oblique to the longitudinal direction and reaches up to the pin receptacle 25, is formed in the carrier 4. A clamping screw 50 is screwed into the latter, which engages with the notch 38 during assembly and abuts a counter-bearing surface formed on the edge side of the notch 38. When tightening the clamping screw 50, the cutting insert 16 is pulled into the plate seat 14 counter to the longitudinal direction z, and the contact surfaces 40A, B; 42A, B are strained against one another so that the desired centering occurs and a safe, centered seat is achieved. To replace the cutting insert 16, only the clamping screw 50 needs to be loosened so that the clamping pin 36 is released. The entire cutting insert 16 can then be pulled out of the plate seat 14 in the longitudinal direction z without any problems, without having to overcome any forces, for example clamping forces. The same applies to the insertion of the cutting insert 16 into the plate seat 14.

1. A rotary tool extending longitudinally from a shank region to a front-facing end region along an axis of rotation and having a carrier with a cutting insert that can be replaceably inserted therein, wherein
the carrier at a front-facing end forms a plate seat comprising two opposing retaining webs, between which a receptacle is formed with a floor into which the cutting insert is replaceably inserted,
a clamping screw is provided, with the aid of which the cutting insert in the receptacle is retracted during assembly of the cutting insert,
the cutting insert comprises a front face with a front cutting tip and two radially outer cutting corners as well as two opposing radial wings,
a center plane is defined, which is subtended in the longitudinal direction through the axis of rotation and in a first transverse direction that extends perpendicular to the longitudinal direction, wherein the center plane passes centrally between the cutting corners and the retaining webs, and wherein a second transverse direction is further defined, which extends perpendicular to the longitudinal direction and perpendicular to the first transverse direction,
respective lateral, radial contact surfaces are formed on a respective retaining web and on a respective wing,
respective axial contact surfaces, are formed on the floor of the plate seat and on the floor side of the wings, wherein
in the assembled state, the respective contact surfaces of the plate seat abut against those of the wings,
at least the axial contact surfaces of the plate seat as well as the axial contact surfaces of the wings, when viewed in a projection in the direction of the second transverse direction, are respectively oriented in a V shape in relation to one another, such that the cutting insert is held centered in the plate seat.

2. The rotary tool according to claim 1, wherein, in addition, the radial contact surfaces, when viewed in a projection in the direction of the first transverse direction, are oriented in a V shape in relation to one another.

3. The rotary tool according to claim 1, wherein the axial contact surfaces, when viewed in a projection in the direction of the first transverse direction, are respectively inclined with respect to the second transverse direction at a respective angle of inclination.

4. The rotary tool according to claim 1, wherein the cutting insert as well as the plate seat have a radially inner center region, and radial guide surfaces are formed at the respective center region of both the plate seat and the cutting insert which, when viewed counter to the longitudinal direction, are oriented at an angle to the radial contact surfaces.

5. The rotary tool according to claim 1, wherein dimensions of the receptacle are such that the cutting insert can be inserted into the receptacle without a bias.

6. The rotary tool according to claim 1, in which the axial contact surfaces respectively enclose an obtuse angle between themselves.

7. The rotary tool according to claim 6, in which the obtuse angle is in the range of 110° to 160°.

8. The rotary tool according to claim 1, wherein the radial contact surfaces enclose an acute angle between themselves.

9. The rotary tool according to claim 8, wherein the acute angle is in the range of 5° to 35°.

10. The rotary tool according to claim 3, wherein the angle of inclination is between 5° and 20°.

11. The rotary tool according to claim 1, wherein the radial contact surfaces are flat surfaces.

12. The rotary tool according to claim 1, wherein the radial contact surfaces extend parallel to the center plane.

13. The rotary tool according to claim 1, wherein the radial contact surfaces extend in the longitudinal direction, at least in a radially outer region, over the entire expanse of the retaining webs and wings.

14. The rotary tool according to claim 1, wherein the axial contact surfaces are flat surfaces.

15. The rotary tool according to claim 1, wherein the axial contact surfaces are cylindrical or conical lateral surfaces.

16. The rotary tool according to claim 1, wherein the cutting insert on the floor side comprises a clamping pin with a notch, and the receptacle on the floor side comprises a pin receptacle in which the clamping pin is inserted when the cutting insert is assembled, wherein the clamping screw engages with the notch of the clamping pin in order to fix the cutting insert and exerts a force on the cutting insert counter to the longitudinal direction.

17. The rotary tool according to claim 16, wherein the carrier comprises a threaded hole extending obliquely with respect to the axis of rotation, through which the clamping screw is passed.

18. A cutting insert for a rotary tool according to claim 1, which is configured so as to be reversibly replaceably inserted into a plate seat of a carrier of the rotary tool and extends in a longitudinal direction along an axis of rotation, wherein
a front face in the longitudinal direction having a front cutting tip and two radially outer cutting corners as well as two opposed radial wings are formed,
a center plane is defined, which is subtended in the longitudinal direction through the axis of rotation and in a first transverse direction that extends perpendicular to the longitudinal direction, wherein the center plane passes centrally between the cutting corners, and wherein a second transverse direction is further defined,
on a respective wing, a lateral, radial contact surface is formed and, on the floor side, a respective axial contact surface is formed, which are configured so as to abut against corresponding contact surfaces of the carrier,
at least the axial contact surfaces, when viewed in a projection in the direction of the second transverse direction, are oriented in a V shape in relation to one another.

19. A carrier for a rotary tool according to claim 1, which carrier extends from a shank region to a front-facing end region along an axis of rotation in the longitudinal direction, wherein
the carrier at a front-facing end forms a plate seat comprising two opposing retaining webs, between which a receptacle is formed with a floor into which a cutting insert is replaceably inserted,
a center plane is defined, which is subtended in the longitudinal direction through the axis of rotation and in a first transverse direction that extends perpendicular to the longitudinal direction, wherein the center plane passes centrally between the retaining webs, and wherein a second transverse direction is further defined, which extends perpendicular to the longitudinal direction and perpendicular to the first transverse direction,
on a respective retaining web, a respective lateral, radial contact surface is formed and, on the floor, two axial contact surfaces are formed, which are configured so as to abut against corresponding contact surfaces of the cutting insert,
at least the axial contact surfaces, when viewed in a projection in the direction of the second transverse direction, are oriented in a V shape in relation to one another.
